(19) United States
(12) Patent Application Publication
(10) Pub. No.: US 2009/0106050 A1
(43) Pub. Date: Apr. 23, 2009

(54) Bioinformation input/output device, bioinformation presenting device, bioinformation input/output method, and computer program

(76) Inventors: Yutaka Ikeda, Ikoma-shi Nara (JP); Hiroaki Niwamoto, Nara-shi Nara (JP); Katsuya Nakagawa, Kizugawa-shi Kyoto (JP)

Correspondence Address: BIRCH STEWART KOLASCH & BIRCH, PO BOX 747, FALLS CHURCH, VA, 22040-0747, US

(21) Appl. No.: 11/921,662

(22) PCT Filed: Apr. 4, 2007
(86) PCT No.: PCT/JP2006/310721

§ 371 Date: Dec. 6, 2007

(30) Foreign Application Priority Data
Jun. 8, 2005 (JP) 2005-168791

(51) Int. Cl. G06Q 50/00

(52) U.S. Cl. 705/3

(57) ABSTRACT

A bioinformation input/output apparatus comprises bioinformation storage means for storing bioinformation in association with a user or users, device information storage means for storing a device(s) in association with the user or users, and bioinformation output means for reading bioinformation stored in the bioinformation storage means and outputting the bioinformation to a device. The bioinformation output means outputs the bioinformation to the device according to the user associated with the device. With this, the bioinformation input/output apparatus outputs bioinformation according to the device.

### TECHNICAL FIELD

The present invention relates to an apparatus, for inputting/outputting bioinformation such as footstep count, weight, heart rate, and blood pressure.

### BACKGROUND ART

Nowadays, there are a lot of common devices and services for measuring personal bioinformation easily without going to a hospital, the bioinformation being used for a health control. As concrete examples, there are a pedometer and a weight scale equipped with a function of measuring body fat rate. In addition, in Non-Patent Document 1: OMRON HEALTHCARE Co., Ltd. “OMRON Health Counter HJ-7101T” Feb. 23, 2004 by OMRON HEALTHCARE Co., Ltd. [Searched on May 8, 2005] on the Internet <URL: http://www.healthcare.omron.co.jp/product/hj_index.html>, discloses data measurement devices for home use, which can perform more special measurements such as a blood-pressure gauge and a pulse meter.

In addition, the Internet has rapidly become common at home. Especially, an access to the Internet through a broadband connection is becoming popular. Using results of a bioinformation data measurement for telediagnosis by connecting a home with a medical institution, for example, is proposed in Patent Document 1: Japanese Unexamined Patent Application Publication No. 2004-321373 (published on Nov. 18, 2004).

However, bioinformation is, by its nature, personal information that belongs to an individual. Therefore, when displaying bioinformation on a device, the bioinformation should not be transferred to the device without considering by whom the device is currently used. Furthermore, privacy levels of bioinformation change according to type and content of the bioinformation. Therefore, some bioinformation can be disclosed to others, but some not be disclosed to others. That is, there are two kinds of bioinformation: information that should be confidential to the individual only, to whom the information belongs, and information that can be shared among people. No solution has been proposed yet to solve the issues of the privacy risks.

In addition, a person having an illness, such as high blood pressure, has a high motive to measure his bioinformation data because he needs to accumulate his daily measurement data. However, people without any illness, unless having a special motive, tend to measure bioinformation data frequently only when they buy a measurement device, but in many cases, the frequency of the measurement falls over time, and then, they end up stopping the measurement. In both the Non Patent Document 1 and Patent Document 1, measuring bioinformation data, referring to results of the measurement and feeding back the results to an action are carried out at request from users. Therefore, people, who are not self-motivated, do not continue the measurement for a long period.

### DISCLOSURE OF INVENTION

The present invention is accomplished in view of the conventional problems. An object of the present invention is to provide an apparatus, which outputs bioinformation depending on a user of a device and a kind of the bioinformation is. A second object of the present invention is to provide an apparatus by which users do not need to intentionally perform an operation to view the bioinformation.

In order to attain the objects, a bioinformation input/output apparatus according to the present invention is a bioinformation input/output apparatus for inputting/outputting bioinformation in order to present the bioinformation to a user, the apparatus including: bioinformation storage means for storing bioinformation in association with the user or users; device information storage means for recording a device in association with the user or the users; and bioinformation output means for reading the bioinformation stored in the bioinformation storage means and outputting the bioinformation to a device, the bioinformation output means performing the output operation of the bioinformation to the device according to the user associated with the device.

According to the above configuration, bioinformation is outputted to a device based on data of a user who is associated with the device so that the user does not need to specify his/her bioinformation to output.

Furthermore, a bioinformation presenting device of the present invention presents bioinformation. In order to attain the objects, the bioinformation presenting device according to the present invention is arranged such that it includes communication means for acquiring the bioinformation through communication; and bioinformation presenting means for presenting, to the user, the bioinformation acquired by the communication means, and that when the bioinformation presenting apparatus is turned on or according to the current time, the bioinformation presenting means acquiring the bioinformation and the bioinformation presenting means presenting the bioinformation.

According to the above arrangement, a user can notice his/her bioinformation through a daily activity in daily life.

Furthermore, in order to attain the objects, the invention is a bioinformation input/output method for inputting/outputting bioinformation in order to present the bioinformation to a user, the method including (a) storing the bioinformation in association with the user or users; (b) recording a device(s) in association with the user or the users; and (c) outputting the bioinformation to a device according to the user associated with the device, the bioinformation being stored in the bioinformation storage means.

### BRIEF DESCRIPTION OF DRAWINGS

FIG. 1 is a block diagram illustrating a functional configuration of a bioinformation input/output apparatus, bioinformation measurement apparatuses, and a bioinformation presenting apparatuses and how they are connected with each other.

FIG. 2 is a flowchart illustrating how the bioinformation input/output apparatus stores the bioinformation.

FIG. 3 illustrates an example of bioinformation, which is stored in a bioinformation storage section of the bioinformation input/output apparatus.

FIG. 4 is an example of device information stored in a device information storage section of the bioinformation input/output apparatus.

FIG. 5 is an example of user information stored in a user information storage section of the bioinformation input/output apparatus.

FIG. 6 is an example of confidentiality information of bioinformation stored in a bioinformation confidentiality storage section of the bioinformation input/output apparatus.

FIG. 7 is an example of priority-given confidentiality information of bioinformation stored in the bioinformation confidentiality storage section of the bioinformation input/output apparatus.

FIG. 8 is a flowchart illustrating a process of the bioinformation input/output apparatus.

FIG. 9 is a flowchart illustrating how the bioinformation input/output apparatus produces outputting-bioinformation.

FIG. 10 is a flowchart illustrating a process of the bioinformation presenting apparatus.

FIG. 11 is an example of presentation by a bioinformation presenting apparatus (TV).

FIG. 12 is a flowchart illustrating a process of the bioinformation presenting apparatus.

FIG. 13 is an example of presentation by a bioinformation presenting apparatus (portable telephone).

FIG. 14 is a second example of presentation by the bioinformation presenting apparatus (TV).

FIG. 15 is a third example of presentation by the bioinformation presenting apparatus (TV).

FIG. 16 is a flowchart illustrating how the bioinformation presenting apparatus performs processes for presenting the bioinformation.

FIG. 17 is a forth example of presentation by the bioinformation presenting apparatus (TV).

### BEST MODE FOR CARRYING OUT THE INVENTION

### First Embodiment

A first embodiment of the present invention is described below with reference to the attached drawings. Meanwhile, the same symbols are used to label the same parts and same functions in figures. Therefore, detailed explanations for the same parts and the same functions are not repeated.

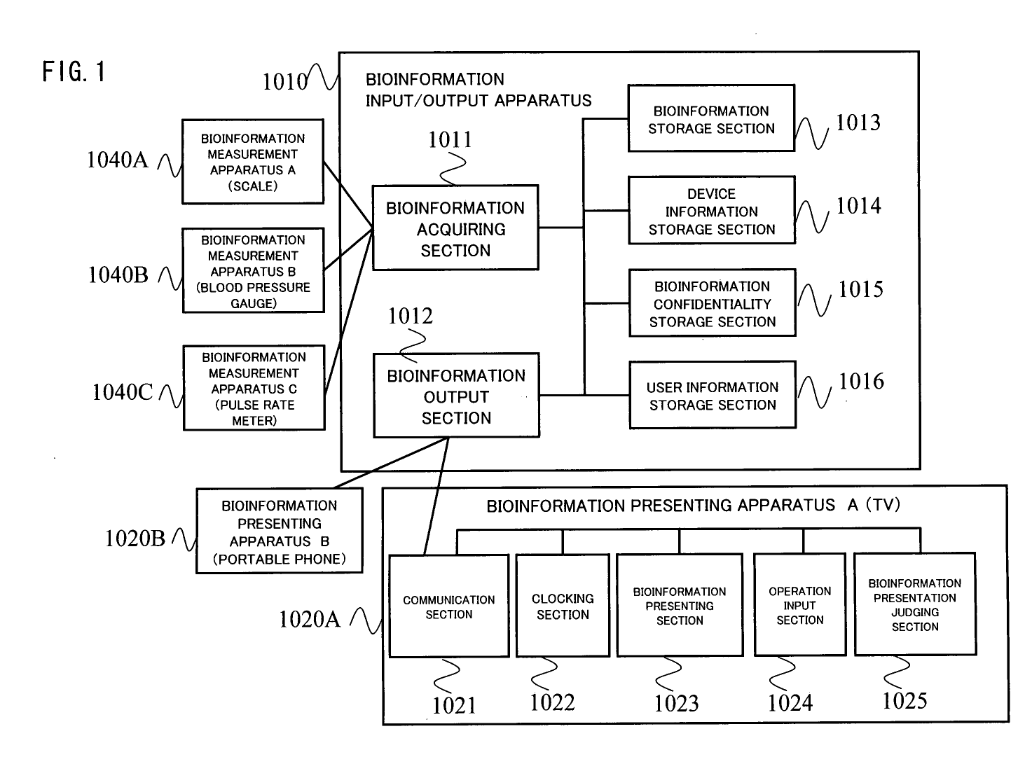

FIG. 1 is a diagram illustrating a functional configuration of a bioinformation input/output apparatus 1010 and a bioinformation presenting apparatus 1020.

As illustrated in FIG. 1, the configuration includes a bioinformation measurement apparatus 1040 for measuring bioinformation data, the bioinformation presenting apparatus 1020 for presenting bioinformation data measurement results, and the bioinformation input/output apparatus 1010 for outputting to bioinformation presenting apparatus 1020 the results of the bioinformation data measurement performed by the bioinformation measurement apparatus 1040.

The bioinformation measurement apparatus 1040 is an apparatus, which can measure one or more different types of data concerning a living body. The information is such as footstep count, weight, body fat rate, blood pressure, heart rate and the other. These days, there are a variety of bioinformation measurement apparatus 1040.

Apart from apparatuses having a measurement function(s) only, some of them are apparatuses that have a measurement function in addition, such as a portable phone being equipped with a pedometer function. The bioinformation measurement apparatus 1040 transfers a measurement result to the bioinformation input/output apparatus 1010 at a predetermined timing. The predetermined timing may be varied based on a measurement frequency, a meaning of measurement data, or the like: the timing may be immediate after the measurement or some time after the measurement (e.g., an hour or a day after the measurement) after a certain amount of measurement data being accumulated.

As illustrated in FIG. 1, the bioinformation input/output apparatus 1010 comprises a bioinformation acquiring section 1011 for acquiring bioinformation from the bioinformation measurement apparatus 1040, a bioinformation storage section 1013 for storing the bioinformation, which is acquired by the bioinformation acquiring section, the bioinformation being stored in association with type information and user data thereof, a device information storage section 1014 for storing device information such as possessor data and confidentiality (for instance, whether the device is owned privately or shared) of the bioinformation presenting apparatus 1020 and the bioinformation measurement apparatus 1040, a bioinformation confidentiality storage data section 1015 for storing information regarding which type of the bioinformation stored in the bioinformation storage section 1013 is confidential, a user information storage section 1016 for storing gender and age-related data of a user such as birth date, and a bioinformation output section 1012 for reading data of the bioinformation stored in the bioinformation storage section 1013 and for outputting the bioinformation to the bioinformation presenting apparatus 1020. In addition, the bioinformation output section 1012 determines an output manner. This determination includes determination whether to output the bioinformation. The bioinformation output section 1012 decides the output manner based on the following data: the possessor data of the bioinformation presenting apparatus 1020, which the information stored in the device information storage section 1014 designates as an output destination; the confidentiality of the bioinformation presenting apparatus 1020; confidentiality of the bioinformation based on who is the user of the bioinformation and which type the bioinformation is, the bioinformation being stored in the bioinformation confidentiality storage section 1015. The bioinformation output section 1012 outputs the bioinformation according to the output manner.

Next, the bioinformation presenting apparatus 1020 includes a communication section 1021 for communicating with the bioinformation input/output apparatus 1010 in order to perform the acquisition of the bioinformation or the like operation, a clocking section 1022 for indicating a current time, a bioinformation presenting section 1023 for outputting the acquired bioinformation, an operation input section 1024 for accepting an operation input from a user via buttons or a remote controller, a bioinformation presentation judging section 1025 for judging whether to present the bioinformation to a user through the bioinformation presenting section 1023.

Meanwhile, each of the above apparatus includes a microcomputer, which has a central processor unit and storage etc. The latter mentioned operations are implemented by computer programs stored in the storages.

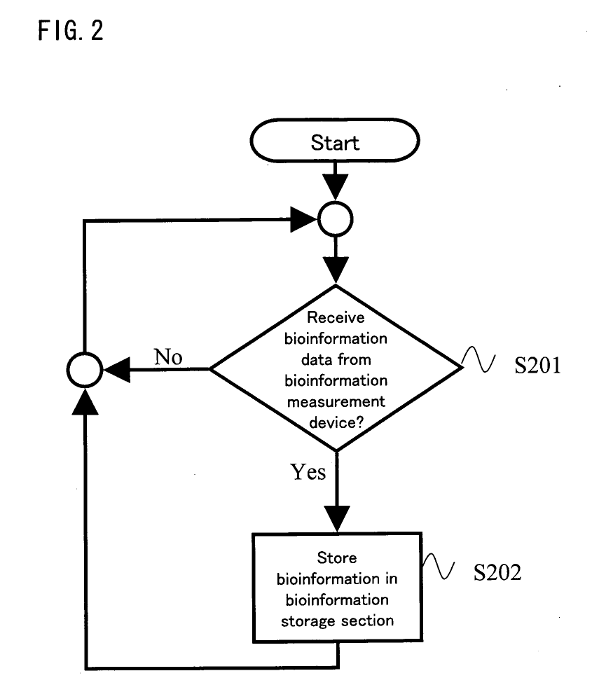

FIG. 2 illustrates a flow, wherein the bioinformation acquiring section 1011 acquires bioinformation from the bioinformation measurement apparatus 1040, and then stores the bioinformation to the bioinformation storage section 1013. Firstly, the bioinformation acquiring section 1011 is in a standby state for receiving bioinformation from the bioinformation measurement apparatus 1040 (S201). If the bioinformation acquiring section 1011 receives the bioinformation (Yes at S201), the bioinformation acquiring section 1011 stores the bioinformation in the bioinformation storage section 1013 (S202).

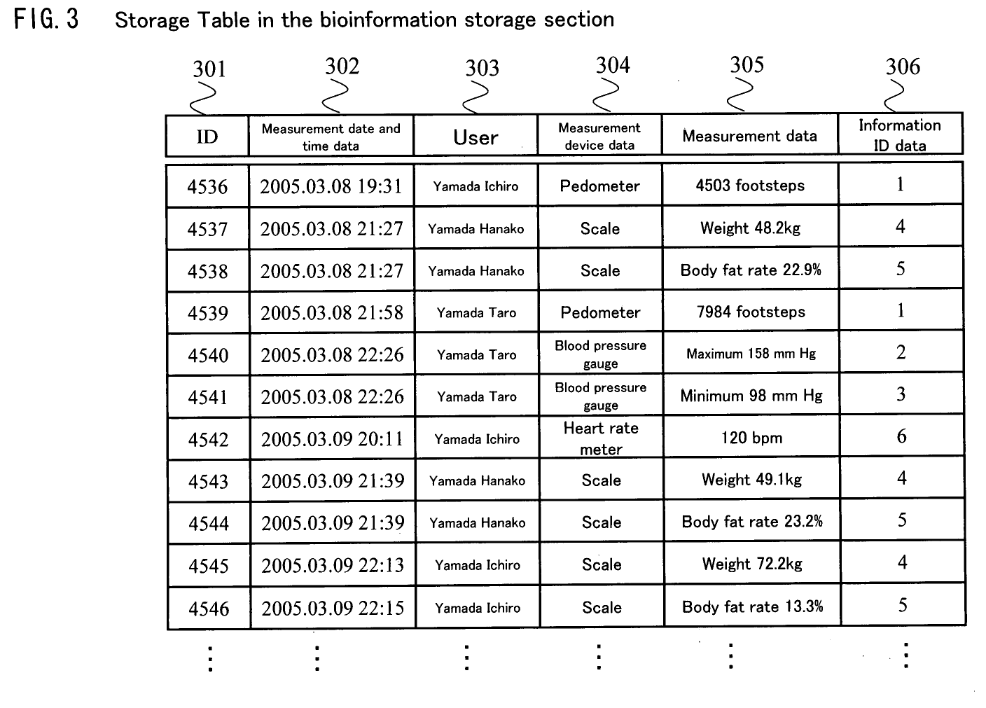

FIG. 3 illustrates an example of bioinformation stored in the bioinformation storage section 1013 of the bioinformation input/output apparatus 1010. As illustrated in FIG. 3, each bioinformation is stored in the bioinformation storage section 1013 in association with the following data: bioinformation identifier 301 as an identifier of the bioinformation stored in the bioinformation storage section 1013; measurement time data 302 indicating date and time at when the bioinformation is measured; user data 303 indicating a person who uses the bioinformation (the person the bioinformation belongs to); measurement device data 304; measured data 305, which is the bioinformation itself; and information ID data 306 indicating type of the bioinformation.

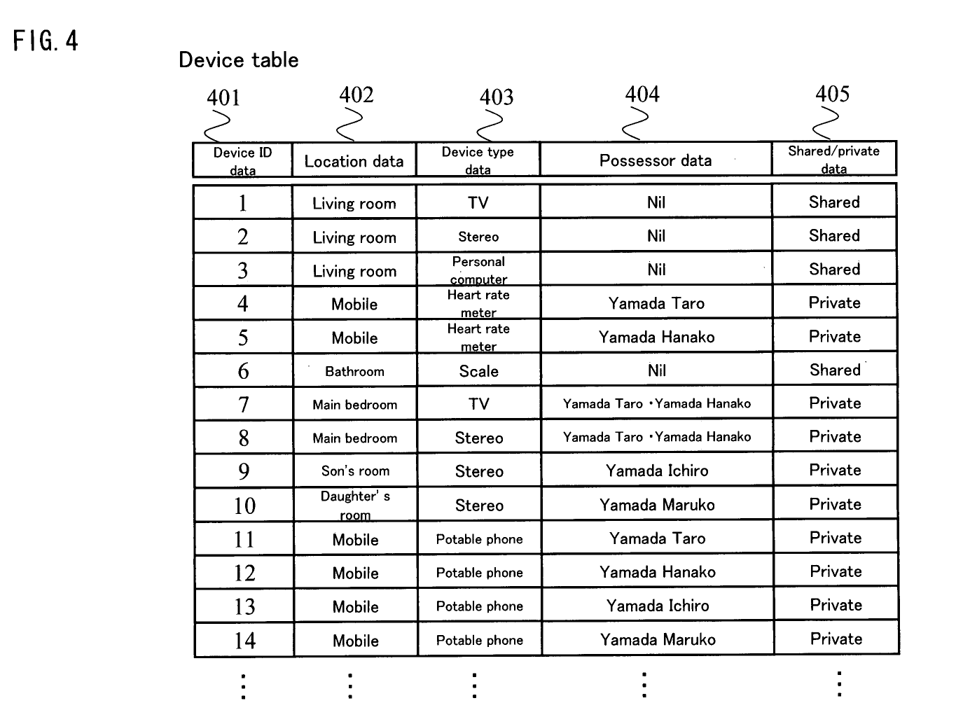

FIG. 4. illustrates an example of device information stored in the device information storage section 1014 of the bioinformation input/output apparatus 1010. As illustrated in FIG. 4, each device information is stored in the device information storage section 1014 in association with the following information: device information ID identifier 401 as an identifier of the device information in the device information storage section 1014; location data 402 indicating a location where a device is placed; type data 403 indicating type of a device, possessor data indicating a possessor of a device, and shared/private data 405 indicating confidentiality of a device: whether the device is shared or used privately.

For example, the bioinformation presenting apparatus 1020A (TV) in FIG. 4 corresponds to a TV: “1” in the device information ID data 401, meanwhile the bioinformation presenting apparatus 1020B corresponds to a portable phone: “11” to “14” in the device information ID data 401. The bioinformation measurement apparatus (scale) corresponds to a scale: “6” in the device information ID data 401.

In addition, at S202, the bioinformation, which is received from the bioinformation measurement apparatus 1040, is stored in the bioinformation storage section 1013 in association with the possessor information of the bioinformation measurement apparatus 1040 from which the bioinformation is received, the possessor information being stored in the apparatus information storage section 1014. In the case where possessor data indicates that the bioinformation measurement apparatus 1040 is shared, the following arrangements are also possible. In one arrangement, the bioinformation measurement apparatus 1040 identifies a user thereof of bioinformation when measuring the bioinformation, and stores the specified user in association with the bioinformation. And then, the bioinformation acquiring section 1011 receives the user data together with the bioinformation from the bioinformation measurement apparatus 1040 and then the bioinformation is stored in association with this user data. As an alternative, in the case where a user of bioinformation is identifiable from properties of the bioinformation, the identified user is recorded as the user data of the bioinformation.

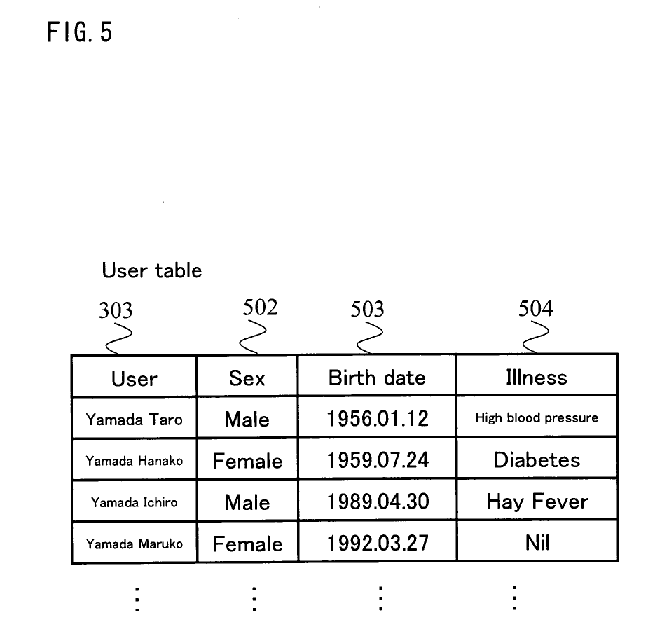

FIG. 5 illustrates an example of user information in the user information storage section 1016 of the bioinformation input/output apparatus 1010. As illustrated in FIG. 5, each user information is stored in association with the following data: the user data 303; sex data 502 indicating sex of a user; birth date data 503 which is age-related information of the user; illness data 504 indicating an illness the user has, and/or the other data.

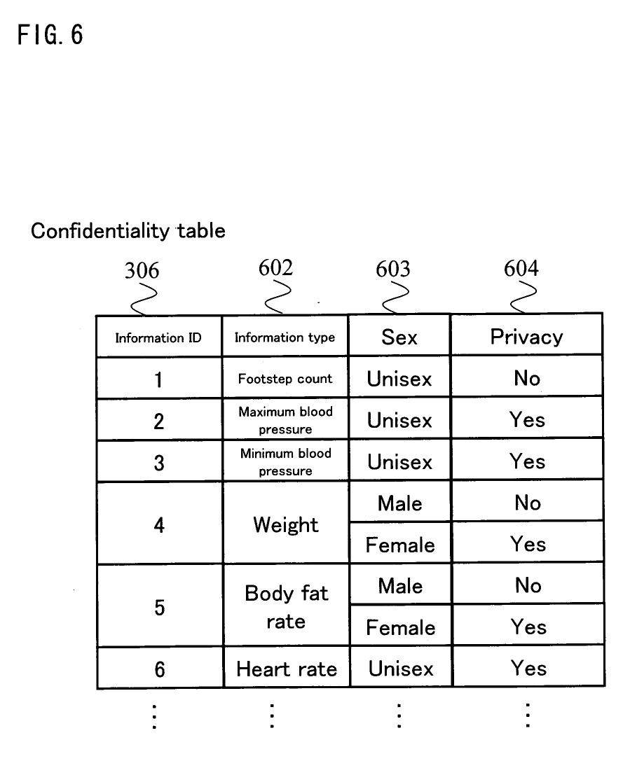

The bioinformation confidentiality storage section 1015 stores the confidentiality information and priority-given confidentiality information of various types of the bioinformation. FIG. 6 illustrates an example of the confidentiality information concerning various types of the bioinformation stored in the bioinformation confidentiality storage section 1015. As illustrated in FIG. 6, bioinformation is sorted according to the information ID data 306. At the same time, each of the sorted bioinformation is stored in association with the following data: information type data 602 indicating type of the bioinformation; sex data 603 specifying sex, in case where the gender requires a higher privacy level; privacy data 604 indicating two values, Yes or No, for a determination whether to present bioinformation only to the user, to whom the bioinformation belongs.

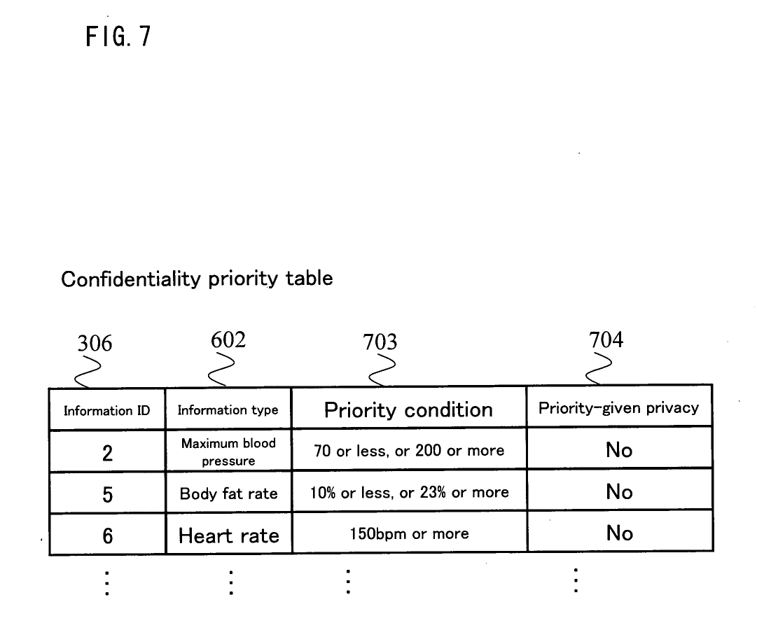

In addition, the bioinformation confidentiality storage section 1015 stores the priority-given confidentiality information. The evaluation of the priority-given bioinformation is carried out with priority to the confidentiality information in the case where detected bioinformation indicates that a user may be in a serious condition or in emergency. FIG. 7 illustrates an example of the priority-given confidentiality information stored in the bioinformation confidentiality storage section 1015. FIG. 7 illustrates the bioinformation types, which possess the priority-given confidentiality information and are sorted according to the information ID data 306. The bioinformation for each information ID data 306 is stored in association with the following data: priority condition 703, which indicates conditions which will give priority to the bioinformation in case where the bioinformation meets this condition; and priority-given privacy 704, whose value is applied in the case where the bioinformation meets the precedence condition data 703.

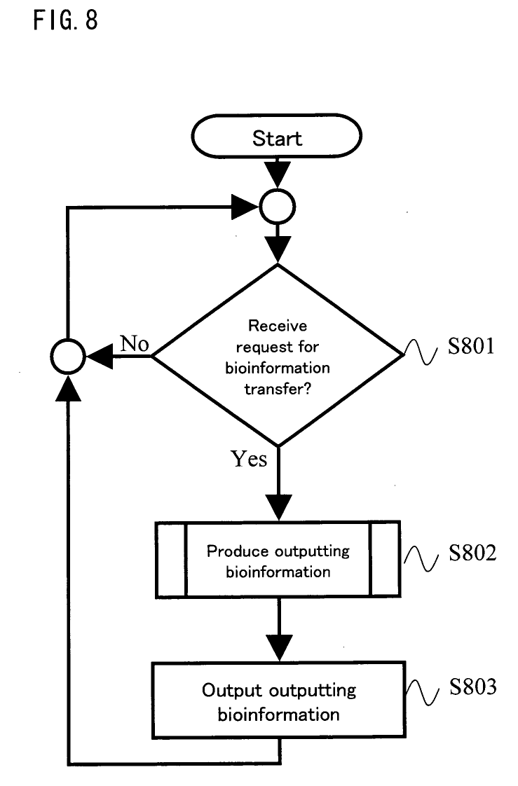

FIG. 8 illustrates a process flow, illustrating how the bioinformation input/output apparatus 1010 deals with a request from the bioinformation presenting apparatus 1020, which requests for bioinformation. The communication section 1021 of the bioinformation input/output apparatus 1010 is standby for receiving a request from the bioinformation presenting apparatus 1020 (S801). If the bioinformation input/output apparatus 1010 receives a request (Yes at S801), it produces outputting-bioinformation that is to be presented through the bioinformation presenting apparatus 1020 (S802). The process for producing the outputting-bioinformation is described later for more details. Next, through the communication section 1021, the bioinformation input/output apparatus 1010 outputs the outputting-bioinformation to the bioinformation presenting apparatus 1020 (S803). Lastly, the process goes back to S801 again.

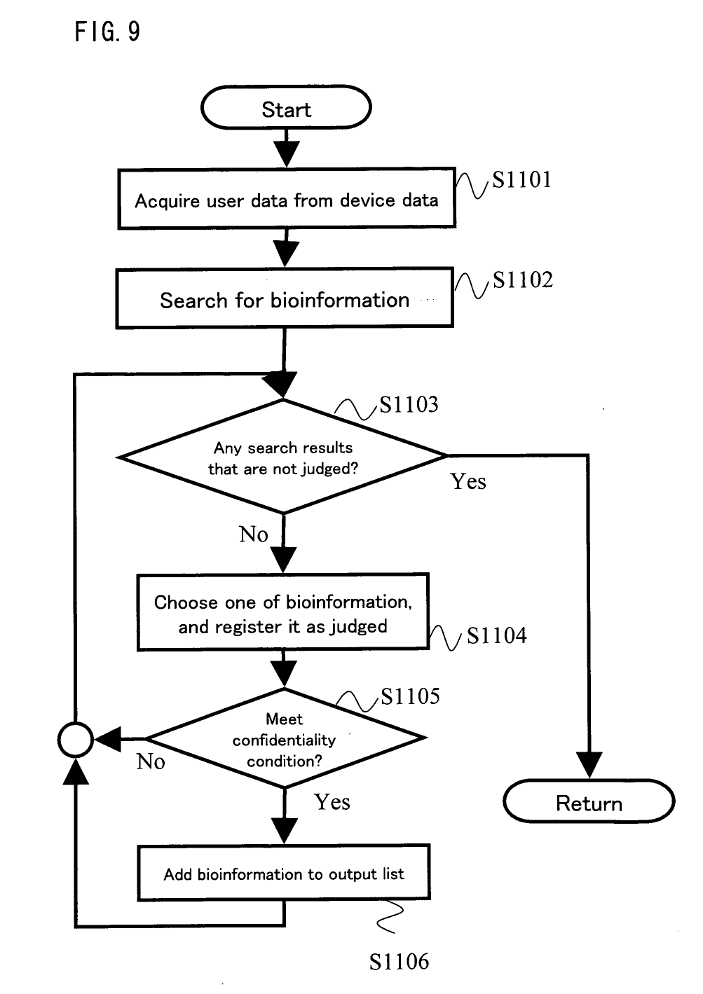

FIG. 9 is a detailed operation flow (S802), wherein the bioinformation output section 1012 produces the outputting-bioinformation of the bioinformation input/output apparatus 1010. Firstly, at S1101, the bioinformation output section 1012 acquires from the device information storage section 1014 the possessor data of the bioinformation presenting apparatus 1020 that is requesting for bioinformation transfer. Next, at S1102, the bioinformation output section 1012 searches for bioinformation based on the possessor data acquired at S1101, and then the bioinformation output section 1012 acquires the bioinformation corresponding to the possessor information. Meanwhile, if the possessor data is not set and the shared/private information is set as “shared”, the bioinformation output section 1012 looks up all users' bioinformation. In addition, the bioinformation data, which was measured for a past predetermined period from a current time, is targeted for the search (in this case, for the past one week from the current time). Then at S1103, the bioinformation output section 1012 examines the searched bioinformation so as to find bioinformation that is not judged by a judging step, which is described later. When the bioinformation output section 1012 detects the bioinformation that is not judged (No at S1103), then the step moves to S1104. At S1104, the bioinformation output section 1012 chooses one of the searched bioinformation that is not judged and then changes it to judged bioinformation.

Next, at S1105, by referring to the confidentiality information stored in the bioinformation confidentiality data storage section 1015, the bioinformation output section 1012 acquires a value in the privacy data 604 of the bioinformation chosen at S1104. In the case where the bioinformation is listed on the priority-given confidentiality list stored in the bioinformation confidentiality data storage section 1015, the bioinformation output section 1012 judges whether a bioinformation measurement data of the bioinformation meets the priority condition 703. If the measurement data meets the priority condition 703, the value in the privacy data 604 is canceled and then a value in the priority-given privacy 704 is applied. In the case where “No” is the value of the priority condition 703/the priority-given privacy 704 stored in the bioinformation confidentiality storage section 1015, bioinformation is judged as not-confidential bioinformation. In the case where “Yes” is the value of the priority condition 703/the priority-given privacy 704 stored in the storage section 1015, the bioinformation is judged as non-confidential bioinformation only if the shared/private information in the device information storage section 1014 is “private” and only the user data of the bioinformation is the possessor data of the bioinformation presenting apparatus. If not, the bioinformation will be judged as confidential bioinformation.

If the bioinformation output section 1012 judges that bioinformation meets the condition of the confidentiality (Yes at S1105), the bioinformation output section 1012 adds the bioinformation to an output list and then the process goes back to S1103. If the bioinformation output section 1012 judges that bioinformation does not meet the condition of confidentiality (No at S1105), the process goes straight back to S1103. The bioinformation output section 1012 repeats the steps of S1104 to S1106 until there is no searched bioinformation that is not judged (Yes at S1103). Next, after going back to the calling routine, the bioinformation input/output apparatus 1010 outputs, at S803 in FIG. 8, the output list to the bioinformation presenting apparatus 1020, which requests for the bioinformation.

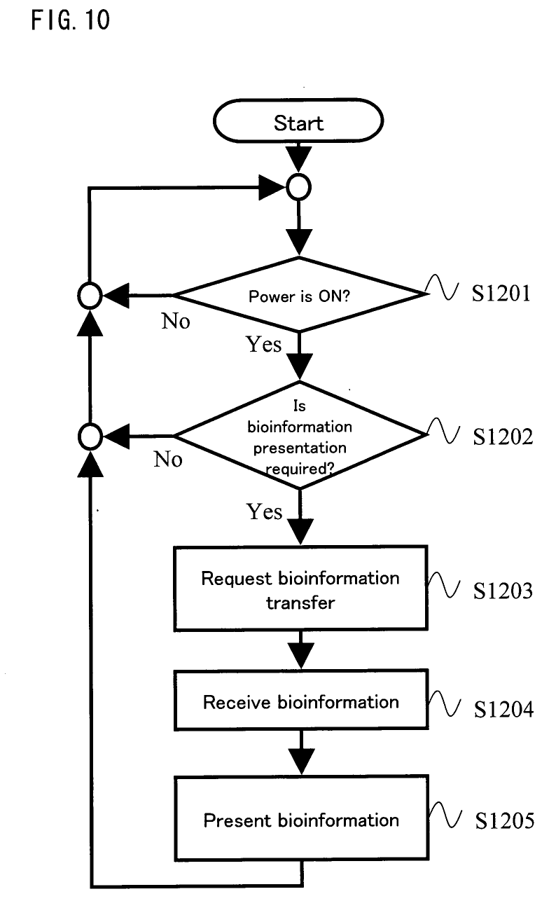

FIG. 10 is an operation flow illustrating operations for presenting bioinformation on the bioinformation presenting apparatus 1020. In the bioinformation presenting apparatus 1020, a power managing section, whose power is constantly on, monitors whether power of the bioinformation presenting apparatus 1020 is ON or OFF (S1201). If the power managing section detects that the power is ON, for example, by a user's operation, the bioinformation presentation judging section 1025 judges whether to request the bioinformation from the bioinformation input/output apparatus (S1202).

In this embodiment, the bioinformation presentation judging section 1025 is controlled to display words “Do you display today's health data?” on a display in the bioinformation presenting apparatus 1020. Based on a user's operation responding to the words, the bioinformation presentation judging section 1025 judges whether to request for the bioinformation.

If the bioinformation presentation judging section 1025 determines to request bioinformation from the bioinformation input/output apparatus (Yes at S1202), the bioinformation presentation judging section 1025 requests the bioinformation from the bioinformation input/output apparatus 1010 through the communication section 1021 (S1203), and receives the bioinformation from the bioinformation input/output apparatus 1010 (S1204) and then presents the bioinformation to the user through the bioinformation presenting section 1026 (S1205).

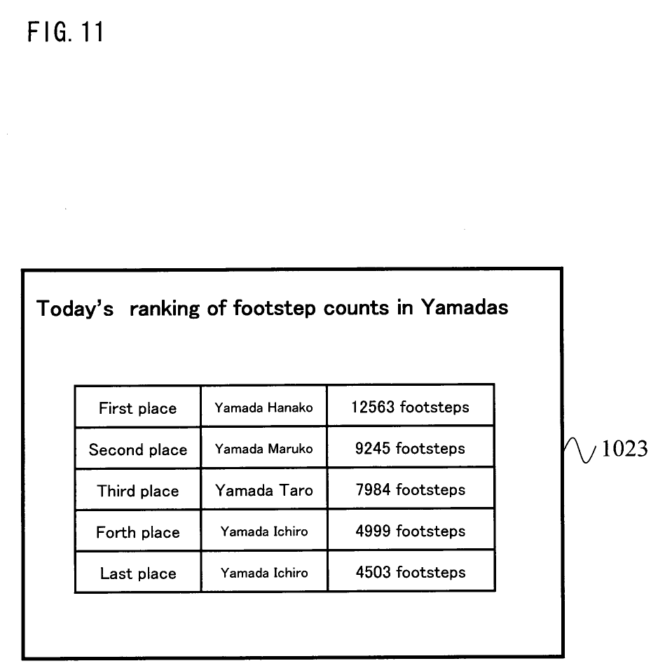

FIG. 11 is a display example illustrating that bioinformation is displayed on the bioinformation presenting section 1023 of the bioinformation presenting apparatus 1020 after the above steps. In FIG. 11, the displayed bioinformation is footstep counts and the bioinformation presenting apparatus 1020 is a TV, whose device information ID data 401 in FIG. 4 is “1” and which is placed in a living room. All users' bioinformation is looked up because the shared/private data 405 in FIG. 4 indicates “shared”. In addition, “No” is applied in the privacy data for all of the users based on a confidentiality information table in FIG. 6.

According to the above arrangement of the bioinformation input/output apparatus 1010 and the bioinformation presenting apparatus 1020 of the present embodiment, upon turning on a common device such as the TV, a user is asked whether to display bioinformation. Thereby, the user can check his/her bioinformation even in the case where he/she loses his/her interest for the bioinformation or forgets to check his/her health condition.

### Second Embodiment

A second embodiment of the present invention is described below with reference to the attached drawings. In the first embodiment, when the bioinformation presenting apparatus 1020 is powered on, the bioinformation presenting apparatus 1020 asks a user whether to present the bioinformation to him/her. In the second embodiment, the bioinformation presenting apparatus 1020 informs a user of the bioinformation appropriately at a predetermined time or in case of emergency. In addition, similar arrangements and operations in the first embodiment are basically used for the second embodiment. Only different features of the operations and configurations are described below.

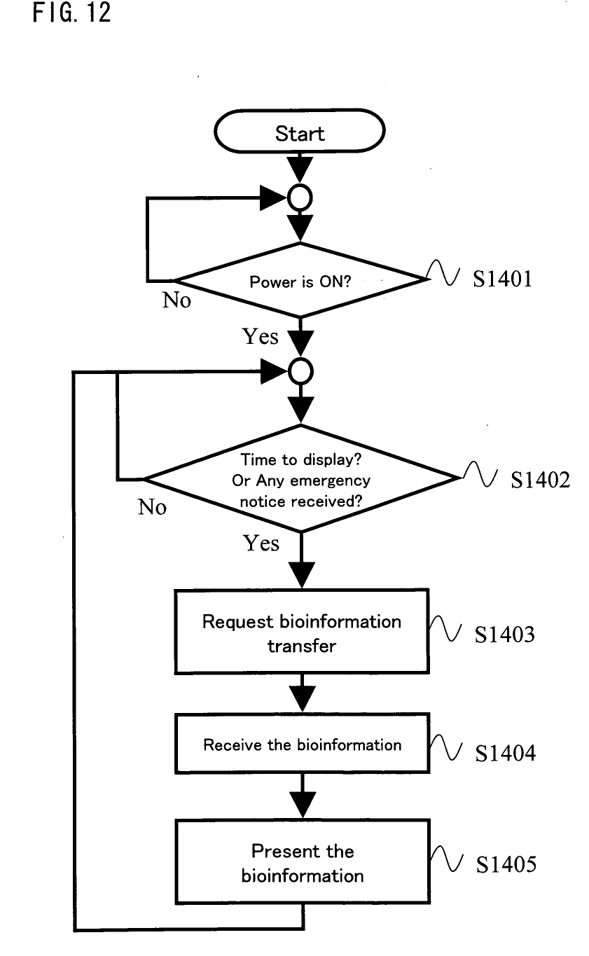

FIG. 12 is an operation flow illustrating operations for presenting bioinformation in the bioinformation presenting apparatus 1020. In the bioinformation presenting apparatus 1020, a power managing section, whose power is constantly on, monitors whether power of the bioinformation presenting apparatus 1020 is ON or OFF (S1401). If the power is applied at the power managing section, for example, by a control of a user (Yes at S1401), the operation moves to S1402. At S1402, the bioinformation presentation judging section 1025 judges whether it is a predetermined time to present the bioinformation according to the clocking section 1022, or the bioinformation presentation judging section 1025 judges whether the communication section 1021 has emergency information. In this embodiment, the predetermined time is set as at three minutes before every exact hour. Of course, the predetermined time is variable and may be every 15 minutes or every predetermined hour passed from the power-on.

In addition, according to the arrangement of the present embodiment, in the case where the acquired bioinformation meets the precedence condition data in FIG. 7 at the bioinformation storage process (S202) in FIG. 2, the bioinformation input/output apparatus 1010 sends an emergency message immediately through the bioinformation output section 1012 to the bioinformation presenting apparatus 1020 which is powered on. Meanwhile, there are a wide range of conventional methods to find out the bioinformation presenting apparatus 1020 which is powered on, such as a polling method and a status notification method. Therefore, details for the methods are not described here.

When it is the predetermined time to present the bioinformation or if the communication section 1021 receives the emergency message at S1402 (Yes at S1402), the operation moves to S1403. At S1403, the bioinformation presentation judging section 1025 requests bioinformation from the bioinformation input/output apparatus 1010 through the communication section 1021 (S1403). Then, the bioinformation presentation judging section 1025 receives the bioinformation from the bioinformation input/output apparatus 1010 (S1404). Then, the bioinformation presentation judging section 1025 presents the bioinformation to the user through the bioinformation presenting section 1026 (S1405).

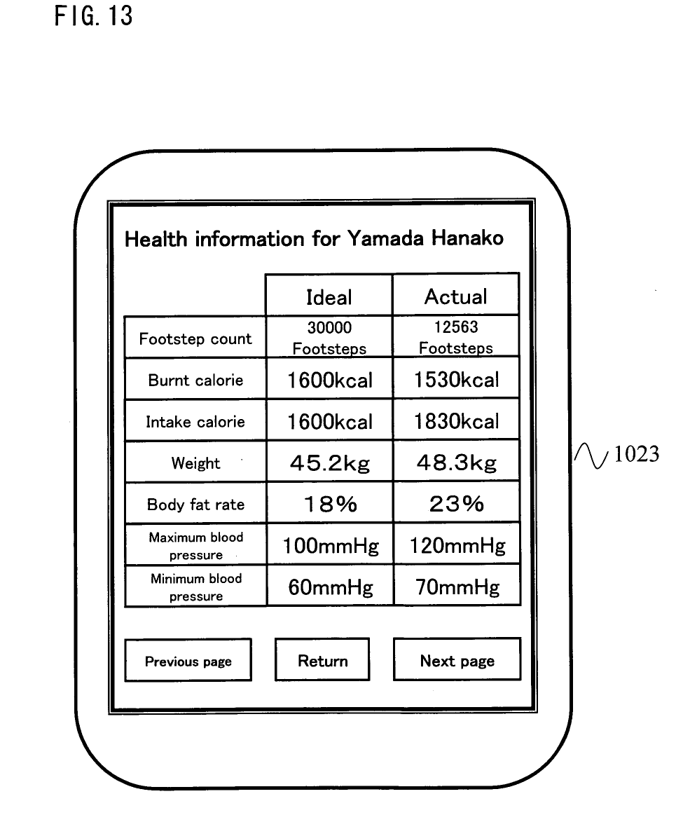

FIG. 13 is a display example illustrating that the bioinformation presenting apparatus 1020 displays bioinformation, which is displayed at three minutes before every exact hour. In this example, the bioinformation presenting apparatus 1020 is a portable phone, whose the device information ID data 401 in FIG. 4 is “12”. According to the device information in FIG. 4, a device applying “12” in the device information ID data 401 possesses the following values: “Yamada Hanako” in possessor data 404 and “private” in the shared/private information 405. Thereby, the bioinformation of Yamada Hanako is searched for. As a result, all types of Yamada Hanako's bioinformation for both “Yes” and “No” in the privacy data are displayed. In this case, the bioinformation is presented as a background of an idle display for a predetermined time period, in this example, for ten minutes. It is also possible to inform the bioinformation by sound at every fixed interval. Moreover, if the portable phone is a foldable type, it is possible to inform the bioinformation in response to a predetermined operation, such as opening the portable phone. In addition, when the bioinformation is presented on receiving the emergency message, the bioinformation is popped up on the idle display, but not as the background. Furthermore, the bioinformation is presented together with either or both of informing sound or vibration that are used, for example, for informing the users of receipt of an incoming mail or call.

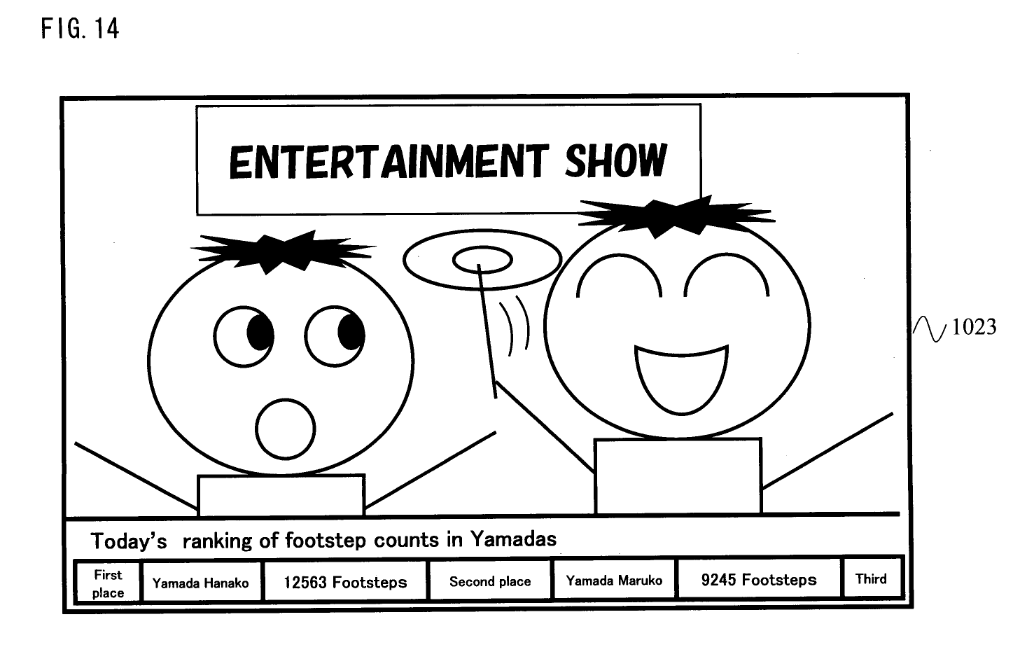

FIG. 14 is another display example illustrating the bioinformation presenting apparatus 1020 displays the bioinformation, which is displayed at three minutes before every exact hour. In this example, the bioinformation presenting apparatus 1020 is a TV. In the case where the bioinformation presenting apparatus 1020 is a displaying device such as the TV, which displays image contents such as TV programs, the bioinformation is presented as a scrolling display on a lower part of a screen for a predetermined period, for example, for ten minutes. Thereby, it is possible to prevent the bioinformation from interrupting a user to watch a program.

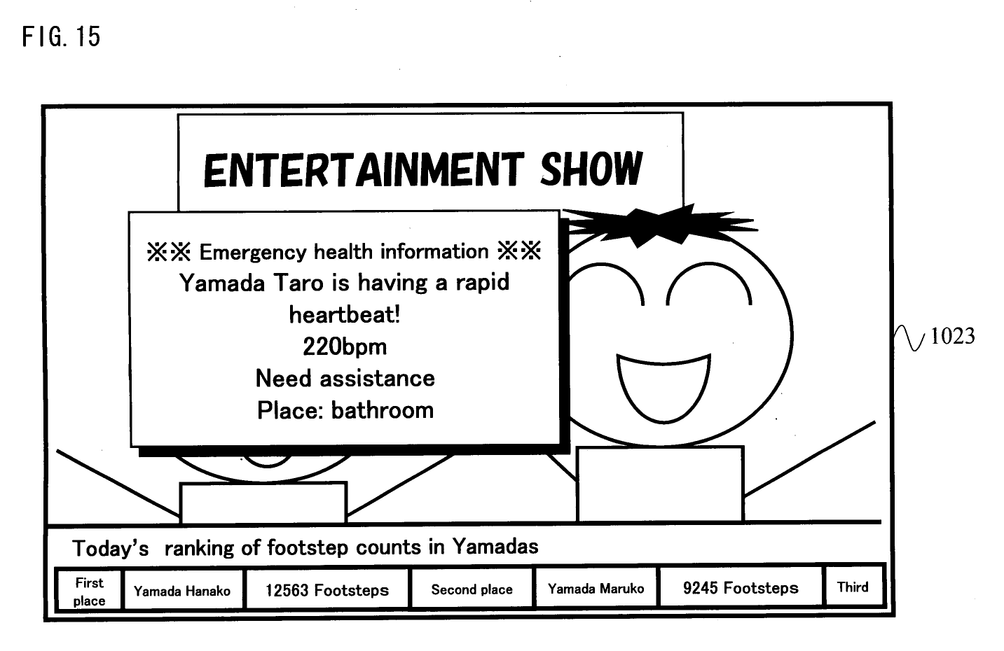

Meanwhile, in the case where there is bioinformation that is regarded as the priority-given condition data, urgent presentation of the bioinformation would be required in some cases. Therefore, as illustrated in FIG. 15, the bioinformation is popped up with priority to the program. Moreover, the bioinformation is presented emphatically with alert sound at a predetermined volume level, irrelevant to a current volume level of the device.

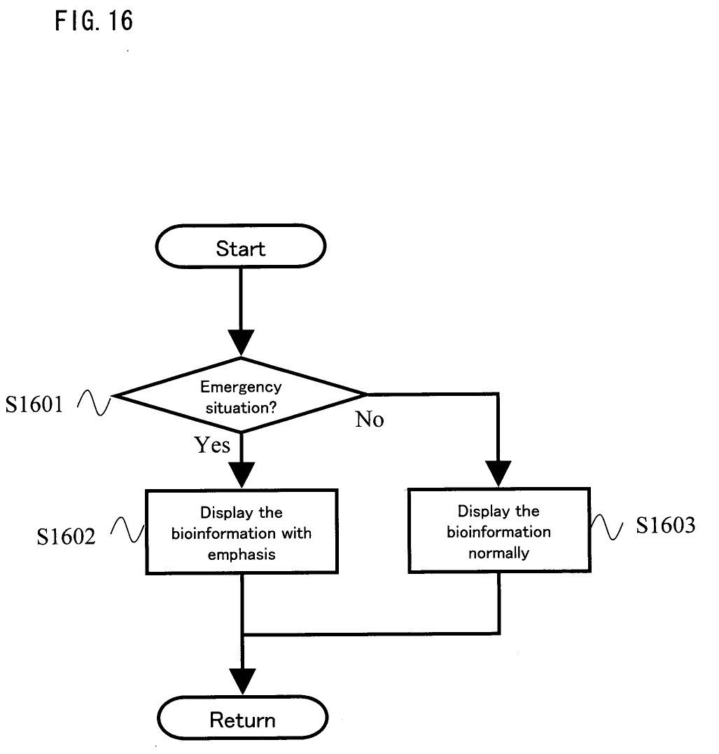

FIG. 16 is an operation flowchart illustrating an operation of the bioinformation presenting processing at S1405 in FIG. 12. The processing is carried out for realizing an emphasized display in case of emergency illustrated in FIG. 15. As illustrated in FIG. 16, at S1601, bioinformation to be presented is judged whether the bioinformation indicates a case of the emergency. In this step, the judgment is made on whether an emergency flag is attached to the bioinformation, or not. The emergency flag is attached to bioinformation by the bioinformation input/output apparatus 1010. Specifically, if the bioinformation, which is received at the bioinformation storage process (S202) in FIG. 2, meets the priority condition, that is set in FIG. 7, the bioinformation input/output apparatus 1010 attaches the emergency flag to the bioinformation, and the bioinformation input/output apparatus 1010 transfers the flag immediately to the bioinformation presenting apparatus 1020. If the bioinformation indicates that it is in case of the emergency at S1601 (Yes at S1601), the step moves to S1602, and then the bioinformation is displayed emphatically on the bioinformation presenting section 1023 as illustrated in FIG. 15. If the bioinformation indicates that it is not in case of the emergency at S1601 (No at S1601), the step moves to S1603, and then the bioinformation is displayed normally as illustrated in FIG. 14. In addition, according to this arrangement, the bioinformation data measurement apparatus 1040 judges whether bioinformation indicates that it is in case of the emergency. In the case where bioinformation is in case of emergency, the bioinformation data measurement apparatus 1040 transfers the bioinformation immediately to the bioinformation input/output apparatus 1010.

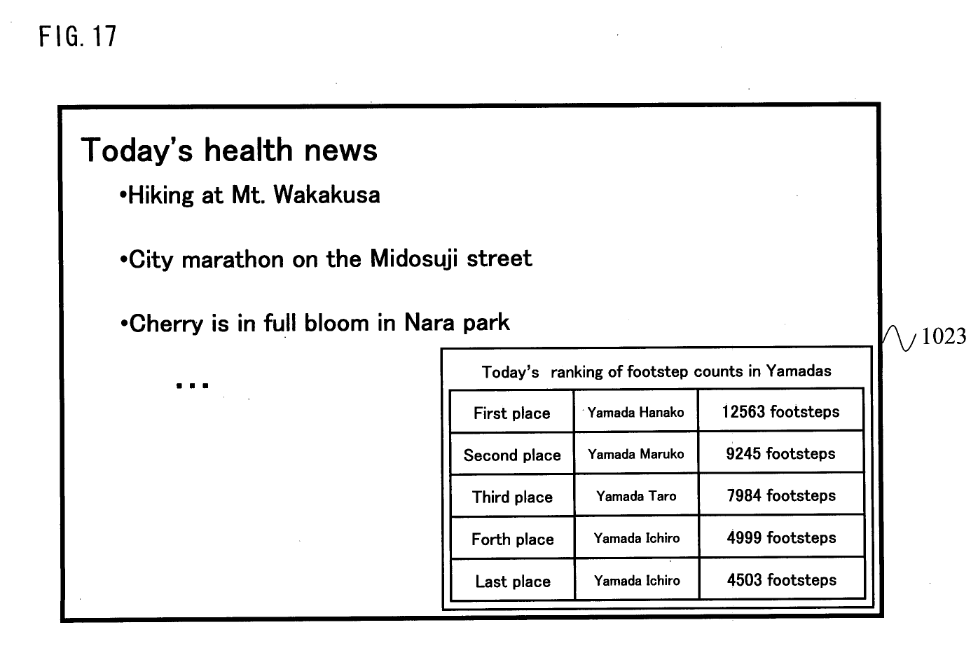

In addition, both the first embodiment and the second embodiment may be arranged such that, as illustrated in FIG. 17, for example, a content, which is related to a user's health condition, is presented when presenting the bioinformation or in response to a predetermined operation. This setting is realized by the steps of: specifying the user's health condition; managing a table (not illustrated), which is associated with contents type related to each health condition; and choosing the contents based on a program type, which is acquired through the data broadcasting, EPG (Electrical Program Guide), and BML (Broadcast Markup Language).

Furthermore, in the case where the bioinformation presenting apparatus 1020 has a user detecting section, which detects a user via a camera or a user-ID-detectable remote controller, this embodiment may be arranged as follows. When the bioinformation presenting apparatus 1020 requests bioinformation data measurement results from the bioinformation input/output apparatus 1010, the bioinformation presenting apparatus 1020 informs the bioinformation input/output apparatus 1010 of the user ID of the detected user. As a result, bioinformation corresponding to the detected user, who is currently using the bioinformation presenting apparatus 1020, is displayed. The following arrangement is also preferable. For example, in the case where the bioinformation presenting apparatus 1020 is a device such as a TV, and only one user is detected by the user detecting section, it is judged that the value in the shared/private data 405 is “private”. Consequently, the bioinformation presenting section 1023 presents the corresponding bioinformation to the detected user while acting as the bioinformation output section 1012.

In addition, the present invention is, of course, applicable not only to the TV and the portable phone, but also to other devices. For example, if the present invention is applied to a radio, the bioinformation may be read out by an audio voice. Of course, the audio voice is applicable to the presentation of the bioinformation on the TV. The present invention is also applicable to a personal computer. Furthermore, recently, some refrigerators have a liquid crystal display and an audio voice output function, so that the present invention is applicable to them.

In the arrangement of the present embodiment, the request for the bioinformation data measurement result in order to present it to the user is initiated by the bioinformation presenting apparatus 1020. However, the present invention is not limited to this. For example, by using the polling method, the bioinformation input/output apparatus 1010 may inquire each bioinformation presenting apparatus 1020 on whether it has a request for the bioinformation, without waiting for the request to come from the bioinformation presenting apparatus 1020. In this arrangement, the bioinformation presenting apparatus 1020 can have a simpler structure. In another arrangement, the bioinformation input/output apparatus 1010 also has a clocking section and instructs the bioinformation presenting apparatus 1020 to present the bioinformation at the predetermined time.

In addition, it is advantageous for a user if the bioinformation presenting apparatus 1020 is set to present the bioinformation to the user at a predetermined timing: when the user is watching evening news, or when a program or Internet contents, which are related to the user's health condition, are outputted.

In addition, in the arrangements of the present embodiments, the privacy data is managed by using two values: Yes/No. At the same time, the device information is also managed by using two values: shared/private. It is also preferable that the privacy information and the device information be managed by classifying the values into finer categories or by more than two levels.

In addition, in the arrangements of the present embodiments, at S1105 in FIG. 9, the privacy of the bioinformation is judged based on a confidentiality table illustrated in FIG. 6. However, another arrangement is also possible. In another arrangement, the judgment is made based on the type of the bioinformation and the measurement data of the bioinformation. Specifically, if a measured weight is heavier than a predetermined weight, the measured weight is judged as “Yes” in the privacy data. Furthermore, as for the step of judging the priority-given confidentiality information in FIG. 7, it is also preferable to judge the bioinformation based on age of and sex of the user, and the measurement data of the bioinformation.

In addition, in the above arrangements of the present embodiments, the bioinformation input/output apparatus 1010 judges it to be an emergency condition in the case where the priority-given privacy is applied to the bioinformation in FIG. 7. However, it is preferable that the bioinformation input/output apparatus 1010 performs the judgment of the emergency condition based on content of the illness data 504 in FIG. 5 together with the priority privacy condition.

In addition, in the arrangements of the present embodiments, the bioinformation input/output apparatus 1010 and the bioinformation presenting apparatus 1020 are configured as independent apparatuses. However, it is possible to realize another configuration with an apparatus such as a hard disk recorder, which acts as home server. In another configuration, the apparatus has functions of both the bioinformation input/output apparatus 1010 and the bioinformation presenting apparatus 1020.

According to the bioinformation input/output apparatus of the present invention, the bioinformation is transferred based on both the user data of each device and shared/private attribute of each device. Thereby, if a device is for private use, a user can acquire and view his/her bioinformation without an operation for specifying the user of the device. At the same time, it is possible to prevent the bioinformation, which the user does not want other users to view, from being presented on a shared device.

Furthermore, even in the case where the user is watching a TV program just for fun (for neither measuring his/her bioinformation nor viewing his/her bioinformation data measurement results), the bioinformation presenting apparatus 1020 requests the bioinformation input/output apparatus 1010 to transfer the bioinformation data measurement results and receives the results therefrom and then presents the results to the user. Thereby, the measurement results are presented to the measurer without taking willingly the steps of viewing his/her bioinformation and checking consciously his/her bioinformation data measurement results. On top of that, common home appliances, such as a TV, a radio, and a refrigerator, can be used as the bioinformation presenting apparatus 1020.

That is, in the case where a bioinformation data measurer uses a device (such as a TV, a radio, or a refrigerator: the device having a different function from a bioinformation measuring function), the bioinformation data can be presented to the measurer, not by the measurer's instruction but by a control from the device (without the measure's intentional control). As a result, it can prevent a situation wherein the measurer neglects to refer to his/her accumulated bioinformation data measurement results. Furthermore, because the measurer can refer to the measurement results regularly, he/she will be motivated to continue the measurement. As a result, the measurer takes an action based on the measurement results. For example, presenting the measurement results regularly to a measurer, who measures his/her footstep counts, encourages him/her to go on a walking and to continue the measurement. As a result, this leads to improve his/her health condition.

In addition, a measurer can continue a measurement, which is challenging to continue in a regular setting, by presenting the measurement results to the measurer even on a day when the measurer does not perform the measurement. For example, there is a measurer who measures his/her weight. Even if the measurer is about to skip the measurement one day, he/she will be encouraged to perform the measurement for the day by being presented with, for example, a list of the measurement results including the results that had been measured until the previous day, without presenting a straightforward comment to urge the measurement.

This arrangement is realized by the following processing. A bioinformation managing section (not illustrated) of the bioinformation input/output apparatus 1010 extracts bioinformation data, at regular intervals, from each user's bioinformation, which is stored in the bioinformation storage section 1013. In this case, the regular intervals are variable such as at a fixed time everyday. The bioinformation data to be extracted is such bioinformation data, which has not been measured for more than a predetermined period (such as two weeks) from the latest measurement. The extraction is carried out based on the latest measurement time stored for each bioinformation type. Then, the bioinformation managing section adds the extracted bioinformation data to a measurement reminder list. At S803, when bioinformation is outputted, the bioinformation is checked against the measurement reminder list. At this step, a predetermined flag is attached to bioinformation that is listed on the measurement reminder list. When bioinformation is presented at S1205, the bioinformation presenting apparatus 1020 outputs the bioinformation with flag with emphasis, or outputs the bioinformation with flag together with a message for urging the measurement.

Moreover, it is possible that the bioinformation input/output apparatus 1010 actively controls an output of bioinformation, without waiting for the requirement for the bioinformation from the bioinformation presenting apparatus 1020. For example, the bioinformation input/output apparatus 1010 can urge the bioinformation presenting apparatus 1020 to output the bioinformation by sending a mail.

Furthermore, it is preferable to set the predetermined period in accordance with properties of each bioinformation type. For example, the predetermined period for blood pressure is 24 hours or loner: measurement results of blood pressure are added to the measurement reminder list when a time period of 24 hours or longer have passed from its latest measurement time. Two weeks or longer can be set for weight and body fat rate measurement.

In the case where the bioinformation presenting apparatus performs at S1205 without regular management performed by the bioinformation input/output apparatus 1010, the present invention may be arranged as follows. If bioinformation data has not been measured for more than the predetermined period from the latest measurement, the bioinformation presenting apparatus 1020 performs the presentation of the bioinformation at S1205 with emphasis according to a current time acquired from the clocking section 1022.

Furthermore, it is preferable that the bioinformation output means determine the output manner of the bioinformation depending on content of the bioinformation.

Thereby, the bioinformation output means can judge emergency conditions (such as heart attack) according to the contents of bioinformation. As a result, it is possible to prevent such a case where emergency information is blocked to due to privacy issues.

Furthermore, it is preferable that the bioinformation output means output the bioinformation to the device according to a current time or when the device is turned on.

Thereby, bioinformation is outputted when a user operates an everyday-use device, or the bioinformation is outputted according to the current time (for example, presentation at regular intervals). As a result, even in the case where the user does not concern much about his/her health condition, or even in the case where the user forgets about his/her bioinformation, the user can check his/her bioinformation and other users' bioinformation.

Furthermore, it is preferable that the bioinformation output means output bioinformation immediately to a predetermined device in case where a situation is specified as an emergency according to the content of the bioinformation.

Thereby, the emergency condition such as heart attack can be recognized according to the content of the bioinformation. As a result, the bioinformation can be presented with emphasis urgently in case of the emergency.

Furthermore, the bioinformation input/output apparatus is preferably arranged such that it further comprises bioinformation acquiring means for acquiring the bioinformation externally from a device, and that the bioinformation storage means storing, in association with the bioinformation acquired externally from the device, a user of the device, who is obtained from device information stored in the device information means.

Therefore, the bioinformation corresponding to a current user, who is currently using a bioinformation presenting device, can be presented even on a device such as a TV, which is used by different users.

Furthermore, it is preferable that the device detect the user thereof and inform the bioinformation input/output apparatus of the user, so that the user is recorded in the device information storage means.

Thereby, in the case where a bioinformation data measurement device is possessed by an individual, it is possible to relate a user of the bioinformation with a user of the bioinformation measurement device without manual setting.

Furthermore, the bioinformation input/output apparatus is preferably arranged such that it further comprises user information storage means for storing user information that regards either sex or age of the user, and that the bioinformation output means performing the determination of the output manner further depending on the user information stored in the user information storage means.

Thereby, it is possible to more thoroughly control levels of the user privacy based on attributes (such as gender or age) of the user information, the levels of the privacy affecting the output manner.

Furthermore, the output manner may be a rule on which a type of bioinformation to be outputted is determined. Thereby, the bioinformation, which requires higher privacy level, can be prevented from leaking to others.

In addition, the bioinformation presenting apparatus is preferably arranged that if the bioinformation presenting means acquires predetermined bioinformation through the communication means, then the bioinformation presenting means emphatically presents the predetermined bioinformation thus acquired.

Thereby, the user can certainly notice important bioinformation.

Furthermore, the bioinformation presenting apparatus is preferably arranged such that it comprises user detecting means for detecting who is a current user, and that the bioinformation presenting means acquiring the bioinformation according to the user detected by the user detecting means, and the bioinformation presenting means presenting the bioinformation thus acquired.

Thereby, even in the case where the presenting device is used by different users, it is possible to present the bioinformation corresponding to a user who is currently using the presenting device.

Furthermore, the bioinformation input/output method is preferably arranged such that the step of recording the device (s) further includes: storing the device(s) in association with confidentiality of the device(s); the step of storing bioinformation further includes: storing the bioinformation in association with type data of the bioinformation; and the step of outputting the bioinformation includes: determining an output manner of bioinformation, the output manner including whether to output the bioinformation or not, and being determined at least depending on the user and confidentiality, which are recorded in the device information storage means, of the device to which the bioinformation is to be outputted; and the user and type data associated with the bioinformation; and outputting the bioinformation in the output manner.

Furthermore, the bioinformation input/output method is preferably arranged such that the step of outputting the bioinformation further includes: outputting the bioinformation to the device when the device is turned on or according to the current time.

Meanwhile, a computer program of the present invention may cause a computer to perform any of the bioinformation input/output methods.

As described above, the bioinformation input/output apparatus of the present invention selectively outputs bioinformation according to data of each output destination device, to which the bioinformation outputted. Thereby, bioinformation belongs to an individual is presented on the device owned by the individual without an operation by the individual for specifying his/her bioinformation. Furthermore, a range of bioinformation to be presented varies according to properties of the bioinformation and to properties of a bioinformation presenting device. Thereby, the bioinformation of a high privacy level is not incautiously disclosed to other users.

As described above, according to the bioinformation input/output apparatus of the present invention, the apparatus is controlled to present the bioinformation without an operation performed by a user for viewing the bioinformation. Thereby, the user does not need to consciously perform an operation to view the bioinformation. As a result, the user can know his/her health condition and pay attention to the health control, even in the case where the user forgets to check the data of the bioinformation.

### INDUSTRIAL APPLICABILITY

According to the present invention, the bioinformation input/output apparatus, bioinformation presenting apparatus, bioinformation input/output methods, and the computer program are useful, for instance, for their user's health control.

1. A bioinformation input/output apparatus for inputting/outputting bioinformation in order to present the bioinformation to a user, comprising:
bioinformation storage means for storing bioinformation in association with the user or users;
device information storage means for recording a device in association with the user or the users; and
bioinformation output means for reading the bioinformation stored in the bioinformation storage means and outputting the bioinformation to a device,
the bioinformation output means performing the output operation of the bioinformation to the device selectively according to the user associated with the device.

2. The bioinformation input/output apparatus as set forth in claim 1, wherein:
the device information storage means records the device(s) further in association with confidentiality of the device(s);
the bioinformation storage means stores the bioinformation further in association with type data of the bioinformation; and
the bioinformation output means determines an output manner of bioinformation, and outputs the bioinformation in the output manner, the output manner including whether to output the bioinformation or not, and being determined at least depending on the user and confidentiality, which are recorded in the device information storage means, of the device to which the bioinformation is to be outputted, and the-type data associated with the bioinformation.

3. The bioinformation input/output apparatus as set forth in claim 1, wherein:
the bioinformation output means outputs the bioinformation further depending on measured data of the bioinformation.

4. The bioinformation input/output apparatus as set forth in claim 1, wherein:
the bioinformation output means outputs the bioinformation to the device according to a current time or when the device is turned on.

5. The bioinformation input/output apparatus as set forth in claim 1, wherein:
the bioinformation output means outputs bioinformation immediately to a predetermined device in case where a situation is specified as an emergency according to the measured data of the bioinformation.

6. The bioinformation input/output apparatus as set forth in claim 1, further comprising:
bioinformation acquiring means for acquiring the bioinformation externally from a device, and the bioinformation storage means storing, in association with the bioinformation acquired externally from the device, a user of the device, who is obtained from device information stored in the device information means.

7. The bioinformation input/output apparatus as set forth in claim 6, wherein: the device detects the user thereof and informs the bioinformation input/output apparatus of the user, so that the user is recorded in the device information storage means.

8. The bioinformation input/output apparatus as set forth in claim 2, further comprising:
user information storage means for storing user information that regards either sex or age of the user, and
the bioinformation output means performing the determination of the output manner further depending on the user information stored in the user information storage means.

9. The bioinformation input/output apparatus as set forth in claim 2, wherein:
the output manner is a rule on which a type of bioinformation to be outputted is determined.

10. A bioinformation presenting apparatus for presenting bioinformation to a user, comprising:
communication means for acquiring the bioinformation through communication; and bioinformation presenting means for presenting, to the user, the bioinformation acquired by the communication means,
when the bioinformation presenting apparatus is turned on or according to the current time, the bioinformation presenting means acquiring the bioinformation and the bioinformation presenting means presenting the bioinformation.

11. The bioinformation presenting apparatus as set forth in claim 10, wherein: if the bioinformation presenting means acquires predetermined bioinformation through the communication means, then the bioinformation presenting means emphatically presents the predetermined bioinformation thus acquired.

12. The bioinformation input/output apparatus as set forth in claim 11 comprising: user detecting means for detecting a current user,
the bioinformation presenting means acquiring the bioinformation according to the user detected by the user detecting means, and the bioinformation presenting means presenting the bioinformation thus acquired.

13. A bioinformation input/output method for inputting/outputting bioinformation in order to present the bioinformation to a user, comprising:
(a) storing the bioinformation in association with the user or users;
(b) recording a device(s) in association with the user or the users; and
(c) outputting the bioinformation to a device according to the user associated with the device, the bioinformation being stored in the bioinformation storage means.

14. The bioinformation input/output method as set forth in claim 13, wherein:
the step (b) further includes:
storing the device(s) in association with confidentiality of the device(s);
the step (a) further includes:
storing the bioinformation in association with type data of the bioinformation; and
the step (c) includes:
determining an output manner of bioinformation, the output manner including whether to output the bioinformation or not, and being determined at least depending on the user and confidentiality, which are recorded in the device information storage means, of the device to which the bioinformation is to be outputted; and the user and type data associated with the bioinformation; and
outputting the bioinformation in the output manner.

15. The bioinformation input/output method as set forth in claim 13, wherein:
the step (c) further includes:
outputting the bioinformation to the device when the device is turned on or according to the current time.

16. A computer program for causing a computer to perform a bioinformation input/output method as set forth in claim 13.

17. The bioinformation input/output apparatus as set forth in claim 1, wherein:
the device information storage means records the device(s) further in association with confidentiality of the device(s); and
the bioinformation output means outputs the bioinformation selectively to a device depending on the confidentiality associated with the device.

18. A bioinformation presenting apparatus for presenting bioinformation to a user, comprising:
communication means for acquiring the bioinformation through communication;
user detecting means for detecting who is a user of the bioinformation presenting apparatus; and
bioinformation presenting means for presenting, to the user, the bioinformation acquired by the communication means,
the bioinformation presenting means notifying, to outside, information of the user detected by the user detecting means, the received bioinformation being selected by an external device according to the information of the user, and the bioinformation presenting means presenting the bioinformation thus selected and received.

19. The bioinformation presenting apparatus as set forth in claim 18, wherein:
if the bioinformation presenting means acquires predetermined bioinformation through the communication means, then the bioinformation presenting means emphatically presents the predetermined bioinformation thus acquired.

20. The bioinformation presenting apparatus as set forth in claim 19 comprising:
user detecting means for detecting who is a current user,
the bioinformation presenting means acquiring the bioinformation according to the user detected by the user detecting means, and the bioinformation presenting means presenting the bioinformation thus acquired.

21. The bioinformation input/output apparatus as set forth in claim 1, being a portable telephone or a television.
